(19) United States
(12) Patent Application Publication
(10) Pub. No.: US 2023/0331227 A1
(43) Pub. Date: Oct. 19, 2023

(54) CONTROL METHOD FOR AUTOMATIC HOLDING, A VEHICLE'S BRAKE SYSTEM AND A BRAKE CONTROL MODULE THEREOF

(71) Applicants: Haldex VIE (Shanghai) Electromechanical Brake System Co., Ltd., Shanghai (CN); Haldex Brake Products Aktiebolag, Landskrona (SE)

(72) Inventor: Christian Rylander, Värmdö (SE)

(21) Appl. No.: 18/212,741

(22) Filed: Jun. 22, 2023

Related U.S. Application Data
(63) Continuation of application No. PCT/EP2021/087391, filed on Dec. 22, 2021.

(30) Foreign Application Priority Data
Dec. 23, 2020 (CN) 202011537119.4

(51) Int. Cl. B60W 30/18; B60W 10/08; B60W 10/184; B60W 40/076; B60W 40/12; B60W 40/13

(52) U.S. Cl. CPC B60W 30/18027; B60W 10/08; B60W 30/18118; B60W 10/184; B60W 40/076; B60W 40/12; B60W 40/13; B60W 2552/15; B60W 2510/182; B60W 2710/083; B60W 2710/182; B60W 2520/28; B60W 2530/10; B60W 2540/103; B60W 2556/20; B60W 2540/12

(57) ABSTRACT

The present invention provides a control method for automatic holding, a vehicle's brake system and a brake control module thereof. The vehicle's brake system comprises two brake control modules and electromechanical brakes controlled by the brake control modules, a drive motor and a drive motor controller for controlling the drive motor. The control method comprises: after the vehicle transitions from moving to stationary, controlling the electromechanical brakes to continuously provide a brake torque, wherein the brake torque is a sum of the effective brake torque and a margin brake torque; and continuously outputting a drive-off signal to the drive motor controller to control the drive motor not to provide drive torque; until a driver requested drive torque is continuously increased to a critical torque which is close to the effective brake torque.

### CROSS REFERENCE TO RELATED APPLICATIONS

This application is a continuation of International Application PCT/EP2021/087391 with an international filing date of Dec. 22, 2021 and claiming priority to co-pending Chinese Patent Application No. CN 202011537119.4 entitled “A control method for automatic holding, a vehicle's brake system and a brake control module thereof”, filed on Dec. 23, 2020.

### FIELD OF THE INVENTION

The invention relates to the field of vehicle braking, in particular to a brake system with two brake control modules and a control method for automatic holding a vehicle with the brake system.

### BACKGROUND OF THE INVENTION

Along with the development of the automobile industry, people have higher and higher requirements on the intelligent degree of vehicles. Vehicle intelligence is typically represented by various assist systems deployed on the vehicle that can improve vehicle driving comfort and convenience. Auto hold is one of the functions that these assist systems can achieve.

The auto holding function is a function of always keeping the vehicle stationary when the driver's intention to start the vehicle is not received after the vehicle is transitioned from moving to stationary. That is, after the automatic holding function is activated, the driver can release the brake pedal after stopping the vehicle, alleviating driving fatigue. In addition, after the vehicle is braked and stopped on a ramp, the automatic holding function can also prevent the vehicle from slipping, and the driving safety and the driving comfort can be improved.

Different from the traditional brake system which adopts gas or liquid as an energy transmission medium, the energy transmission and the signal transmission of the electromechanical brake system (EMB) are realized in an electric form, so that the electromechanical brake system is a vehicle brake system which has a simple structure, quick response and environmental friendliness, and is one of the future development directions in the field of vehicle braking.

In the past, in an electric vehicle equipped with an electromechanical brake system, the automatic holding function is realized mainly by the electromechanical brake system and secondarily by an electric drive system. Although different electric vehicles adopt different control logics to adjust the cooperation between the electromechanical brake system and the electric drive system when implementing the automatic holding function, various problems still exist in the existing electric vehicles when implementing the automatic holding function, for example:
1. the maximum parking braking force is output so as to implement automatic holding no matter how much the road slope is, thereby causing energy waste;
2. energy is wasted when the drive torque is output by the drive system when the brake torque output by the electromechanical brake system is enough to keep the vehicle still;
3. in the transition stage of starting of the vehicle, the switching process between the brake torque output by the electromechanical braking system and the drive torque output by the drive system is not smooth enough, and the vehicle flees due to too large drive torque or slips due to too small drive torque;
4. outputting drive torque from the drive system to hold the vehicle stationary can result in drive motor fatigue, resulting in drive motor damage.

Further prior art is known from European patent application EP 1 616 746 A2, German patent application DE 10 2017 219 921 A1, European patent application EP 2 014 526 A1 and German patent application DE 10 2019 103 375 A1, corresponding to US patent application US 2022/0080942 A1.

### SUMMARY OF THE INVENTION

A brief summary on one or more aspects is given below to provide the basic understanding for these aspects. This summary is not an exhaustive overview of all the contemplated aspects and is neither intended to indicate critical or decisive elements of all aspects nor to attempt to define the scope of any or all aspects. Its sole purpose is to present some concepts of one or more aspects in a simplified form as a preface for a more detailed description presented later.

As described above, in order to solve various technical problems encountered when an electric vehicle equipped with an electromechanical brake system implements an automatic holding function in the prior art, the present invention provides a control method for automatic holding, a vehicle's brake system, and a brake control module thereof.

An aspect of the present invention provides a control method for automatic holding applied to a vehicle's brake system with two brake control modules, the vehicle further comprises a drive motor, and a drive motor controller for controlling the drive motor to provide a drive torque, the brake system further comprises electromechanical brakes controlled by the brake control modules to provide braking force to each wheel, wherein the control method comprises: after the vehicle transitions from moving to stationary, controlling the electromechanical brakes to continuously provide a brake torque, wherein the brake torque is a sum of an effective brake torque and a margin brake torque; and continuously outputting a drive-off signal to the drive motor controller to control the drive motor not to provide drive torque; until a driver requested drive torque is continuously increased to a critical torque which is close to the effective brake torque.

With the novel invention it is possible to provide and/or improve an automatic holding control method, which can be applied to a brake system with electromechanical brake devices, in particular with the aim
to solve the above-described problems,
to achieve an automatic holding function while saving energy as much as possible,
to improve the fatigue life of each mechanical component of the vehicle, and/or
to ensure smoothness and comfort of vehicle operation.

In an embodiment of the above-mentioned control method, optionally, the control method further comprises: when the vehicle is transitioning from moving to stationary, estimating a slope value of a road slope; and estimating the effective brake torque at least based on the slope value.

In the above-mentioned embodiment, optionally, estimating the slope value further comprises: estimating the slope value based on one or more of:
i) acceleration sensor information of the two brake control modules;
ii) a received inclination sensor signal;
iii) a received global positioning system signal and/or topographical information;
iv) a received wheel speed information of the vehicle;
v) inertial sensor information of the two brake control modules; and
vi) torsional load sensor.

In the above-mentioned embodiment, preferably, the control method further comprises: when a plurality of slope values are estimated by a plurality methods, determining a confidence of the road slope based on similarity among the plurality of slope values.

In the above preferred embodiment, optionally, the control method further comprises: determining the critical torque based on the confidence of the road slope; wherein the higher the confidence of the road slope is, the more the critical torque is proximity to the effective brake torque.

In another embodiment, optionally, estimating the effective brake torque further comprises: estimating the effective brake torque based on a mass of the vehicle.

In another embodiment, optionally, the control method further comprises: i) estimating the mass of the vehicle according to driving data; or ii) obtaining the mass of the vehicle from the suspension system.

Optionally, the control method further comprises: when the vehicle is transitioning from moving to stationary, obtaining a request brake torque from a brake pedal to stop the vehicle; and estimating the effective brake torque based on the request brake torque.

Optionally, the control method further comprises: determining the margin brake torque based on a preset fixed value.

Optionally, the control method further comprises: determining the margin brake torque based on a slope value of a road slope and/or a mass of the vehicle, wherein the greater the slope value and/or the mass is, the greater the margin brake torque is.

Optionally, the control method further comprises: determining the margin brake torque based on a confidence of a road slope, wherein the lower the confidence of the road slope is, the greater the margin brake torque is.

In the above-mentioned embodiments, optionally, the control method further comprises: when a rotation signal of motor axles and/or a wheel speed signal of the drive motor is received, increasing the braking force.

Optionally, the control method further comprises: when the driver requested drive torque increases to the critical torque, decreasing the brake torque to the effective brake torque.

Optionally, the control method further comprises: when the driver requested drive torque is continuously increasing after being greater than the critical torque but is less than the effective brake torque, gradually decreasing the brake torque; and outputting a driving enable signal to the drive motor controller to control the drive motor to gradually output the drive torque, wherein a sum of the brake torque and the drive torque is equal to the effective brake torque; until the driver requested drive torque is increased to the effective brake torque.

Optionally, the control method further comprises: when the driver requested drive torque is continuously increased to be greater than the effective brake torque, stopping supplying the brake torque.

Another aspect of the present invention also provides a brake control module of a vehicle's brake system, the brake control module comprises a memory and a processor; wherein the processor is configured to implement the steps of the control method for automatic holding according to any one of the above embodiments.

Another aspect of the present invention also provides a vehicle's brake system, specifically, the brake system comprises two brake control modules as described above and an electromechanical brake controlled by the brake control module to provide braking force to each wheel.

According to the control method for automatic holding, the vehicle's brake system and the brake control module thereof, the effective brake torque for keeping the vehicle static is determined, and the drive system is commanded to adjust the time for responding to the drive request of a driver, so that the automatic holding function is realized while the energy consumption of the whole vehicle is reduced. In addition, the fatigue life of mechanical components of the whole vehicle can be effectively improved because the drive system does not need to respond to the drive request of a driver when the vehicle keeps still.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

After reading the detailed description of the embodiments of the present disclosure in combination with the following drawings, the above features and advantages of the invention can be better understood. In the drawings, the components are not necessarily drawn to scale, and components with similar related characteristics or features may have the same or similar reference marks.

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a schematic structure diagram of the brake system and the drive system according to one aspect of the invention.

FIG. 2 shows a schematic structural diagram of the brake control module according to one aspect of the present invention.

FIG. 3 shows torque-time and speed-time curves obtained after execution of the control method according to one aspect of the present invention.

FIG. 4 shows a flow chart of the control method according to one an aspect of the invention.

### DETAILED DESCRIPTION

The following description is presented to enable any person skilled in the art to make and use the invention, and is incorporated in the context of a particular application. Various modifications, as well as various uses in different applications will be readily apparent to those skilled in the art, and the generic principles defined herein may be applied to a wide range of embodiments. Thus, the present invention is not intended to be limited to the embodiments shown herein but is to be accorded the widest scope consistent with the principles and novel features disclosed herein.

In the following detailed description, numerous specific details are set forth in order to provide a more thorough understanding of the invention. It will be apparent, however, to one skilled in the art that the invention may be practiced without necessarily being limited to these specific details. In other instances, well-known structures and devices are shown in block diagram form, rather than in detail, in order to avoid obscuring the present invention.

The invention is described in detail below with reference to the figures and the specific embodiments. It is noted that the aspects described below in connection with the figures and the specific embodiments are only illustrative and should not be construed as imposing any limitation on the scope of the present invention.

As described above, in order to solve various technical problems encountered when an electric vehicle equipped with an electromechanical brake system implements an automatic holding function in the prior art, the present invention provides a control method for automatic holding, a vehicle's brake system, and a brake control module thereof.

First, please refer to FIG. 1 to understand the brake system according to one aspect of the present invention. The vehicle's brake system according to one aspect of the present invention comprises two redundant brake control modules 110A and 110B and a plurality of electromechanical brake devices 121A, 121B. 121B and 121D which provide braking force for wheels 120A, 120B, 120C and 120D controlled by brake control modules 110A and 110B. In one embodiment, as shown in FIG. 1, the brake system comprises four electromechanical brake devices 121A, 121B, 121B and 121D, which can be respectively set at the right front wheel 120A, the left front wheel 120B, the right rear wheel 120C and the left rear wheel 120D. More specifically, each electromechanical brake device 121A, 121B, 121B and 121D can further comprises a wheel end controller, a motor actuator and a friction brake driven by it, so as to provide brake torque based on the electrical signals output by the brake control module 110A and 110B.

The vehicle to which the brake system is applied also comprises a drive system, which at least comprises a drive motor controller 210 and a drive motor 220 controlled by the drive motor controller 210 to provide drive torque. The brake control modules 110A and 110B according to the invention can communicate with the drive motor controller 210 and output relevant instructions to the drive motor controller 210, so that the drive motor controller 210 can control the drive motor 220 to output or cut off the drive torque in response to the command of the brake control module 110A and 110B.

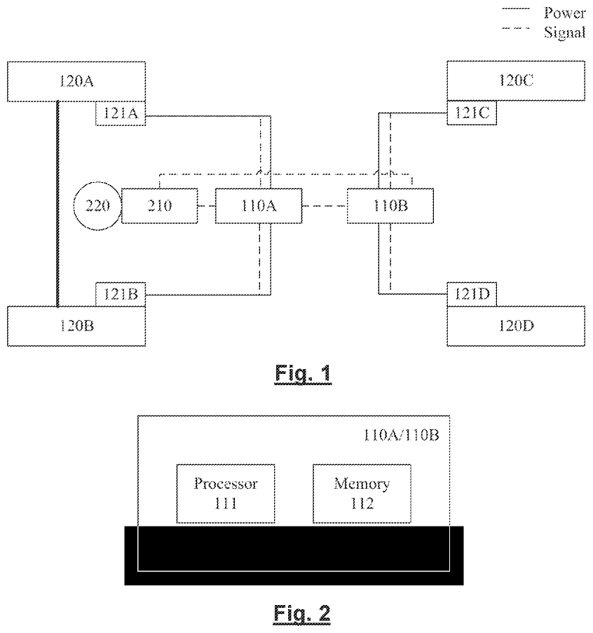

Another aspect of the invention also provides the brake control modules 110A and 110B. Referring to FIG. 2, the above brake control module 110A and 110B respectively comprises processor 111 and memory 112. The processor 111 described above may be a general-purpose processor, such as a microprocessor. However, in an alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such configuration. The memory 112 described above may be any available medium that can be accessed by a computer. As an example and not limited, such memory may comprise RAM, ROM, EEPROM, CD-ROM or other optical disk storage, disk storage or other magnetic storage devices, or any other medium that can be used to carry or store desirable program code in the form of instructions or data structures and can be accessed by a computer.

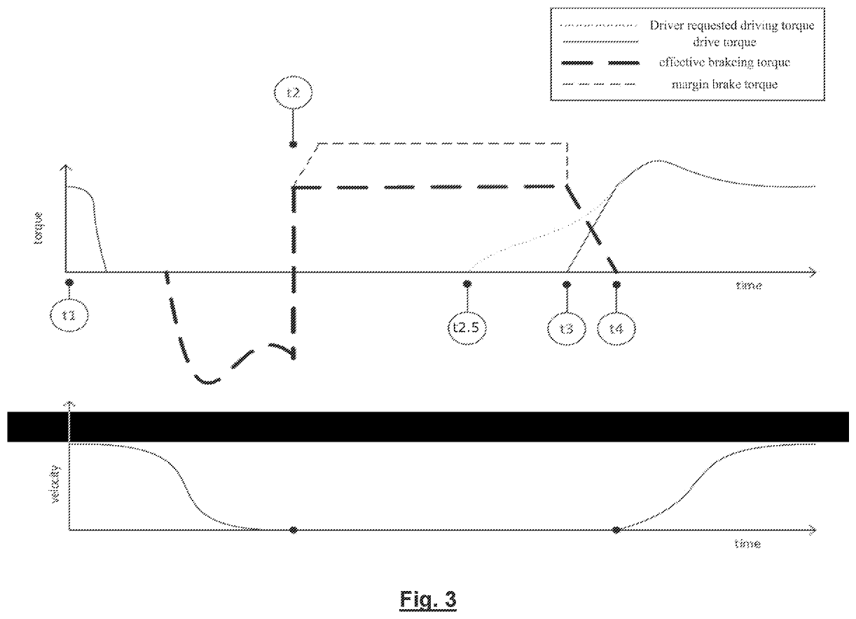

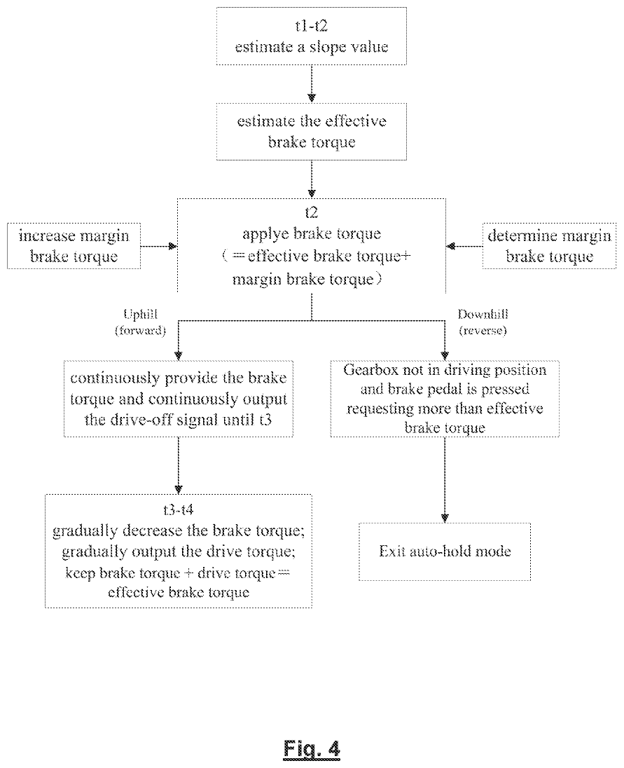

The processor 111 of the brake control module 110A and 110B can realize the automatic holding control method according to one aspect of the invention when executing the computer program stored on the memory 112. A specific implementation method of the control method for the automatic holding will be described below with reference to FIG. 3 and FIG. 4.

The control method according to the invention specifically comprises the following steps: when the vehicle transitions from moving to stationary until the received driver requested drive torque (indicated by a dotted line in FIG. 3) continuously increases to a critical torque close to the effective brake torque (indicated by a thick dotted line in FIG. 3), i.e., the time period t2-t3 in FIG. 3, the electromechanical brake devices 121A, 121B, 121C, 121D are controlled to continuously provide the brake torque and to continuously output the drive-off signal to the drive motor controller 210 so that the drive motor 220 does not provide the drive torque.

Further, during the time period t2-t3, the electromechanical brake devices 121A, 121B, 121C and 121D are controlled to continuously provide the brake torque which is the sum of the effective brake torque and the margin braking torque (indicated by the short dashed line in FIG. 3), so that the vehicle can be kept in a static state during the time period t2-t3.

As can be seen from FIG. 3, from time t2.5, there is already driver requested drive torque. The driver requested drive torque described above may be expressed as a drive torque demand obtained from an accelerator pedal in one embodiment. In the control method according to the invention, when the driver requested drive torque is not large enough to start the vehicle, namely in the time period from t2.5 to t3, the brake torque provided by the electromechanical brake devices 121A, 121B, 121C and 121D can keep the vehicle still, and if the drive system outputs the drive torque in the time period from t2.5 to t3, the waste of energy and the fatigue of the drive motor 220 are caused. According to the invention, the brake control modules 110A and 110B output the drive-off signals, so that the drive system does not respond to the driver requested drive torque, and therefore, the energy-saving effect can be achieved, the working state of the drive system is improved, and the service life of a mechanical component is prolonged.

In the above-described embodiment, the effective brake torque described above is a desired minimum torque for keeping the vehicle stationary. If the vehicle is stopped on a hill, the effective brake torque may correspond to a vehicle weight component parallel to the hill, and if the vehicle is stopped on a flat ground, the effective brake torque may correspond to approximately 0.

Ideally, the effective brake torque is able to maintain the vehicle stationary with minimal energy consumption. Therefore, the determination of the effective brake torque value requires attention.

In another aspect of the control method provided by the present invention, the brake control method further comprises: estimating a slope value of the road slope when the vehicle is transitioning from moving to stationary (during the time period t1-t2); and estimating the effective brake torque based at least on the slope value, as shown in FIG. 4.

In the above-described embodiment, it may be defined that the slope value is 0 if the vehicle is on a flat ground. In the above embodiment, optionally, the slope value of the road is estimated according to one or more of the following:
i) acceleration sensor information of the two brake control modules 110A and 110B;
ii) a received inclination sensor signal;
iii) a received global positioning system signal and/or topographical information;
iv) a received wheel speed information of the vehicle;
v) inertial sensor information of the two brake control modules 110A and 110B; and
vi) torsional load sensor.

Since the slope value of the road may affect the process of the vehicle transitioning from moving to stationary, the road slope value can be reversely estimated from the state information of the acceleration sensor information of the brake control modules 110A, 110B, the wheel speed information of the vehicle, etc. during the process of the vehicle transitioning from moving to stationary.

In addition, when the vehicle is on a road having a slope value, the slope value may be reflected by an inclination sensor, e.g. a pendulum sensor of the vehicle.

Further, a Global Positioning System (GPS) signal and/or topographical information may be combined to obtain a slope value of the current road. For example, to estimate the slope value of the current road on the basis of the vehicle position, the orientation of the vehicle, the topographical information of the position etc. obtained from a navigation system.

Furthermore, since the brake system according to the present invention comprises redundant dual brake control modules, and the dual brake control modules are distributed at different positions of the vehicle, during the driving of the vehicle, if the vehicle drives on a slope, the information obtained by the respective sensors in the dual brake control modules 110A and 110B is different, for example, the data change of the inertial sensor has a time difference, and the slope value can be estimated according to the time difference and the installation distance between the brake control modules. Therefore, it is also possible to estimate the slope value of the road by comparing the sensor information of the two brake control modules 110A, 110B.

It is understood that a plurality of slope values of the road may be estimated in various ways during the time period t1-t2 when the vehicle is transitioning from moving to stationary. In another preferred embodiment, the control method according to the present invention further comprises: determining a confidence level of the road slope based on a similarity among the plurality of slope values.

Those skilled in the art may employ various existing or future mathematical techniques to determine the similarity among the slope values, and the specific manner of calculating the similarity should not unduly limit the scope of the present invention.

In another preferred embodiment, the confidence level is used to determine the critical torque, which may be used to determine the time at which the drive system is to begin responding to the driver requested drive torque, i.e., time t3. The higher the confidence of the road slope is, the closer the estimated effective brake torque is to the ideal effective brake torque, which means that the critical torque is closer to the estimated effective brake torque, and the later the time t3 comes, the later the drive system intervenes to respond to the driver requested drive torque, so that the energy saving effect is better.

After the road slope value is estimated, the effective brake torque may be estimated based on the mass of the vehicle and the road value. In one embodiment, the mass of the vehicle may be a predetermined constant value, such as a service mass of the vehicle. In another preferred embodiment, the control method according to the present invention further comprises acquiring a mass of the vehicle, and estimating the effective brake torque based on the acquired mass of the vehicle.

Further, in the above-described embodiment of obtaining the mass of the vehicle, the estimation may be performed based on the traveling data of the vehicle. For example, when traveling on a flat road with a slope value close to 0, the vehicle mass is estimated from the acceleration and deceleration and the driving-braking torque. Alternatively, in another embodiment, the vehicle mass may be obtained from a suspension system of the vehicle.

In another embodiment, the effective brake torque may also be estimated by obtaining a requested brake torque which bring the vehicle to a standstill during the time period t1-t2 via the brake pedal. If the vehicle is driven by a driver who is very experienced in driving, the requested brake torque required by an experienced driver via the brake pedal when the vehicle is transitioning from moving to stationary is very close to the effective brake torque after the vehicle is stationary in order to smooth the running of the vehicle. Whereas if the vehicle is driven by an inexperienced driver, the requested brake torque bring the vehicle to a standstill collected during the time period t1-t2 via the brake pedal may be greater than the ideal effective brake torque. That is, the requested brake torque bring the vehicle to a standstill collected overtime t1-t2 via the brake pedal may be estimated to be an appropriate effective brake torque greater than the ideal effective brake torque.

In another embodiment, if the vehicle has a constant low-speed coasting condition during the time period t1-t2, the drive torque provided by the vehicle drive system during the constant low-speed coasting condition can be collected, and under the condition that the loss of the transmission system can be ignored, the drive torque is very close to the ideal effective brake torque, which can also be used to estimate the effective brake torque.

While specific embodiments of how to determine the effective brake torque have been described above, it is understood that, although it is desirable to know the ideal effective brake torque to save energy to the maximum extent, due to technical limitations, to avoid large estimation deviations due to the effective brake torque, the control method according to the present invention controls the electromechanical brake devices 121A, 121B, 121C, 121D to output the brake torque as the sum of the estimated effective brake torque and a margin brake torque, in order to save energy as much as possible while ensuring that the vehicle remains stationary.

Therefore, as shown in FIG. 4, the control method of automatic holding provided by the present invention further requires determination of a margin brake torque. In one embodiment, the margin brake torque may be a preset fixed value. The above preset fixed value may be adjusted as required by those skilled in the art to ensure that the vehicle can be kept still.

In another preferred embodiment, the margin brake torque may be determined based on a slope value of the road slope and/or a mass of the vehicle; wherein the larger the slope value of the road slope and/or the mass, the larger the margin brake torque. It will be appreciated that the greater the slope value of the road slope and/or the mass, the greater the absolute value of the effective brake torque required by the entire vehicle, and as a compensation, it is desirable to increase the amount of margin brake torque in proportion to ensure that the vehicle remains stationary.

In another preferred embodiment, the above-described margin brake torque may be determined based on the confidence of the road slope; wherein the lower the confidence of the road slope, the greater the margin brake torque. It is understood that the higher the confidence level of the road slope, the closer the estimated effective brake torque according to the road slope is to the ideal effective brake torque, and therefore, the margin brake torque can be appropriately reduced. Conversely, if the confidence level of the road slope is lower, it means that the difference between the estimated effective brake torque according to the road slope and the ideal effective brake torque is larger, and therefore, the amount of margin brake torque needs to be increased to ensure that the vehicle can be kept stationary.

More preferably, as shown in FIG. 4, the control method for automatic holding according to the present invention further comprises: increasing the braking force when the rotation signal of the motor axles and/or the wheel speed signal of the drive motor 220 is received. When receiving the rotation signal of the motor axles and/or the wheel speed signal of the driving motor 220, it means that the brake torques provided by all the electromechanical brake devices 121A, 121B, 121C, 121D are not enough to keep the vehicle stationary, and therefore, the margin brake torques need to be added on the basis of the received signals, so as to prevent the vehicle from continuously rolling.

By outputting the control command during the period t2.5-t3 so that the drive system does not respond to the driver requested drive torque, the drive torque output while the vehicle is held stationary can be effectively saved, and the fatigue state of the mechanical components of the drive system can be improved.

More preferably, the control method for automatic holding according to the present invention also aims to improve the smoothness of the vehicle when the vehicle starts. As described above, when the driver requested drive torque gradually increases to the critical torque (at the time t3), which means the driver has already had a need to take off. Since the drive system does not respond to the driver requested drive torque in the time period from t2.5 to t3, if the drive torque corresponding to the driver requested drive torque and capable of starting the vehicle is directly output, the vehicle has a large jerk and the driving experience is affected. Therefore, in order to smooth the vehicle start, when the driver requested drive torque increases to the critical torque, that is, at time t3, the brake torque output by the electromechanical brake devices 121A, 121B, 121C, 121D is first controlled to decrease to the estimated effective brake torque.

Subsequently, in response to the driver requested drive torque being greater than the critical torque and then continuously increasing but less than the effective brake torque, i.e., during the time period t3-t4 in FIG. 3, the electromechanical brake devices 121A, 121B, 121C, 121D are controlled to gradually decrease the output brake torque, and a drive enable signal is output to the drive motor controller 210 to enable the drive motor 220 to gradually output the drive torque. Also, it is necessary to control the sum of the brake torque output by the electromechanical brake devices 121A, 121B, 121C, 121D and the drive torque output by the drive motor 220 to be equal to the estimated effective brake torque so that the vehicle remains stationary.

Until time t4 when the driver requested drive torque has increased to the estimated effective brake torque, meaning that the vehicle will be launched when the driver increases the driver requested drive torque again. At this time, as can be seen from the above description and FIG. 3, the brake torque has been reduced to zero, and it is the drive torque output by the drive motor 220 that keeps the vehicle stationary.

And after t4, the driver requested drive torque continues to increase to be greater than the effective brake torque described above. The vehicle has started, ceases to provide brake torque, and the drive system is made to respond fully to the driver requested drive torque.

In another aspect of the control method for automatic holding according to the present invention, as shown in FIG. 4, if it is determined that the vehicle is currently in a downhill state, the gearbox of the vehicle is currently not in a forward gear, and the driver requests a brake demand greater than the effective brake torque via the brake pedal, it indicates that the driver wishes to implement reverse at this time, and thus the vehicle is controlled to exit the automatic holding mode, and the entire drive system and the brake system are completely responsive to the states of the accelerator pedal and the brake pedal.

The control method for the automatic holding, the vehicle's brake system and the brake control module thereof according to the present invention have been described so far. The invention realizes the automatic holding function and reduces the energy consumption of the whole vehicle at the same time by determining the effective brake torque for keeping the vehicle static and commanding the drive system to adjusting the timing for responding to the driver requested drive demand. In addition, the fatigue life of mechanical components of the whole vehicle can be effectively improved because the drive system does not need to respond to the drive request of a driver when the vehicle keeps still.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Many variations and modifications may be made to the preferred embodiments of the invention without departing substantially from the spirit and principles of the invention. All such modifications and variations are intended to be included herein within the scope of the present invention, as defined by the following claims.

I claim:

1. A control method for automatic holding applied to a brake system of a vehicle with two brake control modules, wherein the vehicle further comprises a drive motor, and a drive motor controller for controlling the drive motor to provide a drive torque, the brake system further comprises electromechanical brakes controlled by the brake control modules to provide braking force to each wheel, the control method comprising:
after the vehicle transitions from moving to stationary,
a) controlling the electromechanical brakes to continuously provide a brake torque, wherein the brake torque is a sum of an effective brake torque and a margin brake torque; and
b) continuously outputting a drive-off signal to the drive motor controller to control the drive motor not to provide drive torque;
until a driver requested drive torque is continuously increased to a critical torque which is close to the effective brake torque.

2. The control method according to claim 1, the control method further comprising: when the vehicle is transitioning from moving to stationary,
a) estimating a slope value of a road slope; and
b) estimating the effective brake torque at least based on the slope value.

3. The control method according to claim 2, wherein estimating the slope value further comprises:
estimating the slope value based on one or more of:
i) acceleration sensor information of the two brake control modules;
ii) a received inclination sensor signal;
iii) a received global positioning system signal and/or topographical information;
iv) a received wheel speed information of the vehicle;
v) inertial sensor information of the two brake control modules; and
vi) torsional load sensor.

4. The control method according to claim 3, the control method further comprising:
when a plurality of slope values are estimated by a plurality of methods, determining a confidence of the road slope based on similarity among the plurality of slope values.

5. The control method according to claim 4, the control method further comprising: determining the critical torque based on the confidence of the road slope; wherein the higher the confidence of the road slope is, the more the critical torque is in proximity to the effective brake torque.

6. The control method according to claim 2, wherein estimating the effective brake torque further comprises:
estimating the effective brake torque based on a mass of the vehicle.

7. The control method according to claim 6, the control method further comprising at least one of:
i) estimating the mass of the vehicle according to driving data; and
ii) obtaining the mass of the vehicle from the suspension system.

8. The control method according to claim 1, the control method further comprising:
when the vehicle is transitioning from moving to stationary,
a) obtaining a request brake torque from a brake pedal to stop the vehicle; and
b) estimating the effective brake torque based on the requested brake torque.

9. The control method according to claim 1, the control method further comprising:
determining the margin brake torque based on a preset fixed value.

10. The control method according to claim 1, the control method further comprising:
determining the margin brake torque based on a slope value of a road slope and/or a mass of the vehicle, wherein the greater the slope value and/or the mass is, the greater the margin brake torque is.

11. The control method according to claim 1, the control method further comprising:
determining the margin brake torque based on a confidence of a road slope, wherein the lower the confidence of the road slope is, the greater the margin brake torque is.

12. The control method according to claim 9, the control method further comprising:
when a rotation signal of motor axles and/or a wheel speed signal of the drive motor is received, increasing the braking force.

13. The control method according to claim 10, the control method further comprising:
when a rotation signal of motor axles and/or a wheel speed signal of the drive motor is received, increasing the braking force.

14. The control method according to claim 11, the control method further comprising:
when a rotation signal of motor axles and/or a wheel speed signal of the drive motor is received, increasing the braking force.

15. The control method according to claim 1, the control method further comprising:
when the driver requested drive torque increases to the critical torque, decreasing the brake torque to the effective brake torque.

16. The control method according to claim 1, the control method further comprising:
when the driver requested drive torque is continuously increasing after being greater than the critical torque but is less than the effective brake torque,
a) gradually decreasing the brake torque; and
b) outputting a driving enable signal to the drive motor controller to control the drive motor to gradually output the drive torque, wherein a sum of the brake torque and the drive torque is equal to the effective brake torque;
until the driver requested drive torque is increased to the effective brake torque.

17. The control method according to claim 15, the control method further comprising:
when the driver requested drive torque is continuously increasing after being greater than the critical torque but is less than the effective brake torque,
a) gradually decreasing the brake torque; and
b) outputting a driving enable signal to the drive motor controller to control the drive motor to gradually output the drive torque, wherein a sum of the brake torque and the drive torque is equal to the effective brake torque;
until the driver requested drive torque is increased to the effective brake torque.

18. The control method according to claim 1, the control method further comprising:
when the driver requested drive torque is continuously increased to be greater than the effective brake torque, stopping supplying the brake torque.

19. The control method according to claim 15, the control method further comprising:
when the driver requested drive torque is continuously increased to be greater than the effective brake torque, stopping supplying the brake torque.

20. A brake control module of a vehicle's brake system comprising a memory and a processor; wherein the processor is configured to implement the steps of the control method for automatic holding according to claim 1.

21. A vehicle's brake system comprising two brake control modules according to claim 20 and electromechanical brakes controlled by the brake control modules to provide braking force to each wheel.
